(19) United States
(12) Patent Application Publication
(10) Pub. No.: US 2019/0257293 A1
(43) Pub. Date: Aug. 22, 2019

(54) WIND FARM AIRCRAFT BEACON SYSTEM AND WIND FARM HAVING SAID SYSTEM AS WELL AS METHOD FOR PROVIDING A WIND FARM WITH A BEACON

(71) Applicant: Wobben Properties GmbH, Aurich (DE)

(72) Inventors: Stephan HARMS, Upgant-Schott (DE); Helge GIERTZ, Leer (DE)

(21) Appl. No.: 16/310,113

(22) PCT Filed: Jun. 19, 2017
(86) PCT No.: PCT/EP2017/064943

§ 371 Date: Dec. 14, 2018

(30) Foreign Application Priority Data
Jun. 20, 2016 (DE) 10 2016 111 222.4

(51) Int. Cl. F03D 80/10; G06K 9/00; H04N 7/18

(52) U.S. Cl. CPC F03D 80/10; G06K 9/00201; F05B 2270/8041; H04N 7/181; G06K 9/0063

(57) ABSTRACT

A wind farm aircraft beacon system and also to a wind farm with such a wind farm aircraft beacon system and to a method for beaconing a wind farm. A plurality of aircraft beacon devices and also at least one camera for receiving images and an evaluation device for detecting flying object positions. The evaluation device detects flying object positions by evaluating the camera data, in particular images recorded. Furthermore, the wind farm aircraft beacon system comprises a switching device for switching on or off at least one of the aircraft beacon devices in dependence on the flying object positions detected by the evaluation device.

### BACKGROUND

### Technical Field

The invention relates to a wind farm aircraft beacon system, i.e., to a system for flight restriction beaconing for a wind farm, and to a wind farm with such a wind farm aircraft beacon system. The invention also relates to a method for beaconing a wind farm.

### Description of the Related Art

The prior art discloses systems for flight restriction beaconing, also referred to below for brevity as systems for aircraft beaconing or aircraft beacon systems, that are used for beaconing the wind power installations of a wind farm.

The aircraft beaconing comprises one or more lights, which are arranged on the wind power installations and are used to make flying objects aware of wind power installations situated in the region of the flight path in poor visibility or nighttime darkness.

A multiplicity of different aircraft beacon systems for wind farms are known. According to a first system, for example, controlling of the lights of the aircraft beacon system is carried out in such a way that they are switched off during the day in order to save energy. However, daytime-dependent control of the aircraft beaconing entails the problem that poor visibility, for which it is necessary to switch the aircraft beaconing on, may also occur during the day. Furthermore, continuous beaconing of the wind power installations during the night is a nuisance for residents in the region of the wind power installations.

More refined proposals have therefore already been made for switching the aircraft beaconing on when it is required. Such a requirement occurs when a flying object is approaching the region of a wind power installation or a wind farm.

According to these known aircraft beacon systems, the approach of the flying objects is sensed, for example by means of passive secondary radars, which detect a transponder signal of a flying object and, in dependence on the detection, switch the lights on or off. These systems are however dependent on external signals, such as here the transponder signal of the flying object.

Also known are independent systems, in the case of which a plurality of active radars are provided on each wind power installation of a wind farm, so that it is possible to dispense with a transponder signal of the flying objects. However, active radars are very expensive.

Because of the high cost of active radars, proposals have been made for other alternative systems, which for example provide microphone arrays for detecting flying objects by their emitted noise, and therefore for switching the lights on or off in dependence on the detection of the noise.

Although various solutions for wind farm aircraft beacon systems are already known, either they are very expensive to implement or malfunctions cannot entirely be ruled out. For example, in the case of passive radar systems, transmission units of the flying objects for transmitting the transponder signal may fail.

The German Patent and Trademark Office has searched the following prior art in the priority application for the present application: U.S. Pat. Pub. No. 2016/0053744 A1, U.S. Pat. Pub. No. 2014/0313345 A1 and U.S. Pat. Pub. No. 2011/0043630 A1.

### BRIEF SUMMARY

Provided is an alternative to the already known systems, by which on the one hand malfunctions, for example due to absent transponder signals, are minimized, and on the other hand a favorable and reliable wind farm aircraft beacon system is provided.

A wind farm aircraft beacon system, i.e., a system for flight restriction beaconing of the wind power installations of a wind farm, is proposed. The wind farm aircraft beacon system comprises a plurality of aircraft beacon devices, which in particular comprise lights. The wind farm aircraft beacon system also comprises at least one camera for recording images. The camera is for example designed for recording images or videos.

The wind farm aircraft beacon system also has an evaluation device, by means of which the positions of flying objects, i.e., flying object positions, can be determined. The evaluation device determines the flying object positions by evaluating the camera data, in particular the images recorded by the camera. By means of at least one switching device, at least one of the aircraft beacon devices is switched on or off in dependence on the flying object positions determined by the evaluation device.

The use of radar or transponder systems, which are very expensive, is therefore unnecessary. The invention also represents a reliable alternative. A failure of the camera—by contrast with a failing flight transponder—would be noticed immediately. It is accordingly possible to react immediately to the fault case of a failing camera, by for example the flight beacon devices being switched on permanently.

According to one embodiment, in the evaluation device the flight paths of flying objects are sensed by means of image processing software on the basis of the camera data, i.e., the images recorded. The flying objects can for example be tracked precisely. It is therefore also possible that the objects entering the region of the wind farm and leaving this region are not only precisely tracked, but for example even counted. By comparing the number of objects entering and leaving, it is therefore always known whether at the time there are objects, i.e., flying objects, in the region of the wind power installation that require switching on of the aircraft beacon devices.

According to a preferred embodiment, it is also even possible in the case where a flight path does not leave the region of the wind farm again—which may for example be the case with the landing of a rescue helicopter—that the aircraft beacon devices stay switched on until it leaves the region of the wind farm again. According to a further embodiment, however, the aircraft beaconing only stays switched on for a predefined period of time, for example one day, since the case may also be envisioned that a flying object lands in the region of the wind farm and is then transported away on the ground, so that the flight path can never leave the region of the wind farm.

According to a further embodiment, the camera has a lens. The lens of the camera and the evaluation device are coordinated in such a way as to sense flying objects, in particular independently of their size, that are positioned within a predefined first distance from the camera and/or not to sense flying objects that lie outside a predefined second distance.

Accordingly, therefore, a first distance and a second distance are fixed and the lens and the evaluation device are coordinated in such a way as to sense all flying objects of interest that are closer to the camera than is defined by the first distance, which for instance can also be achieved by a certain design of software of the evaluation device. Accordingly, although for instance a small aircraft is only detected at a smaller distance from the camera than a larger flying object, as a result of the design or coordination of the lens and the evaluation device, large and small flying objects are in any case sensed whenever they come closer than a first distance from the camera.

Alternatively or in addition, all flying objects of interest that lie further away from the camera than is defined by the second distance are not sensed. Accordingly, on account of the design or coordination of the lens and the evaluation device, large and small flying objects are in any case specifically not sensed when they are further away than a second distance from the camera.

According to a further embodiment, at least one camera is an infrared camera. An infrared camera, which is also known as a thermal imaging camera, is an imaging device similar to a conventional camera, which however receives infrared radiation. Infrared radiation lies in the wavelength range from about 0.7 μm to 1000 μm. Therefore, the use of such a camera for detecting flying objects is also possible during darkness at night. The camera is preferably horizontally and/or vertically pivotable and/or rotatable, so that the entire airspace around a wind power installation or a wind farm can be monitored with a single camera.

According to a further embodiment, at least one camera is a photo and/or video camera. A photo and/or video camera also allows use for switching a flight beacon by day. The camera is preferably horizontally and/or vertically pivotable and/or rotatable, so that the entire airspace around a wind power installation or a wind farm can be monitored with a single camera.

According to a further embodiment, the camera is a stereoscopic camera or a camera operating on the basis of a stereoscopy process. Alternatively or in addition, the wind farm aircraft beacon system has at least two cameras. Advantageously, the distance from detected flying objects is consequently also possible in a simple way. Although the distance can also be detected by just one camera, for example by carrying out an edge contrast measurement such as is known from the area of passive autofocusing, a distance detection is performed more quickly and more accurately with two cameras.

Accordingly, therefore, first an object is detected for example with image processing software in the evaluation device on the basis of the camera data, i.e., in particular in the images recorded by the camera. Then, the distance and/or the height of the detected object, i.e., its position, is/are determined. On the basis of the position determined, it is then decided with the evaluation device whether one or more aircraft beacon devices must be switched on or off.

According to a further embodiment, the wind farm aircraft beacon system comprises at least three cameras. Furthermore, the cameras can be arranged at a distance from one another. This makes it possible to counteract in spite of a hindrance in the image region for example of one of the cameras, which may occur for example due to rotor blades of another wind power installation.

Alternatively, the cameras can be arranged essentially at the same position, so that it is possible to dispense with pivotability or rotatability of the cameras, while a 360-degree all-round region can nevertheless be monitored. It is consequently possible to dispense with moving parts, which require maintenance work.

According to a further embodiment, the wind farm aircraft beacon system comprises at least one distance measuring device, in particular with a transit-time measurement, such as a sonar device, laser range measuring device or laser distance measuring device. A distance measuring device, such as for example a sonar device or a laser distance measuring device, that operates on the basis of the transit-time measuring principle consequently therefore allows the use of a single camera and at the same time precise distance or range measurement with respect to an object detected by the camera by means of the distance measuring device.

According to a further embodiment, the wind farm aircraft beacon system comprises at least one receiver for receiving signals of mobile transmitters, in particular radio flight transponders. Accordingly, the mobile transmitter is for example a radio flight transponder, which may be arranged in flying objects and emits an identifier, for example a 24-bit identifier, with which the flying object can be sensed uniquely, or at least the type of flying object can be sensed. The receiver of the wind farm aircraft beacon system receives this signal and can therefore uniquely classify an object detected by the transmitting and receiving station and track its flight path.

Flying objects which for example have crossing flight paths can therefore be distinguished clearly from one another.

Furthermore, redundant sensing of flying objects in the region of the wind farm is possible, since on the one hand the by means of the signals of the mobile transponders and on the other hand the by means of the evaluation device flying objects entering the region of the wind farm can be sensed.

According to a further aspect of this exemplary embodiment, the flight paths of flying objects which are detected by means of the signals of mobile transmitters and also by means of the evaluation device are stored for predetermined periods of time, for example one year or six months.

The stored data can be retrieved during a maintenance interval of the wind farm aircraft beacon system, and are then used to verify correct functioning of the wind farm aircraft beacon system. For this purpose, for example, the positions detected for the same flying object at the same times in the different ways are compared. In the event of a match, a correctly functioning wind farm aircraft beacon system can be assumed, while if there is not a match it can be concluded that there is a malfunction.

According to a further embodiment, a sector can be defined in the switching device for the wind farm. This sector corresponds in particular to the aforementioned region of the wind farm. The switching device is then designed to switch on, or to have switched on, at least one, a plurality or all of the aircraft beacon devices when one or more flying object positions that lie within the predefined sector around the wind farm are detected by means of the evaluation device.

According to a further embodiment, the switching device is also designed to switch off, or to have switched off, at least one of the aircraft beacon devices when no flying object positions, i.e., no flying objects with positions, that lie within the predefined sector around the wind farm are detected by means of the evaluation device.

Accordingly, the definition of a sector establishes a region around the wind farm which, for example according to statutory regulations or guidelines, is defined as a region in which the presence of a flying object must lead to the switching on of aircraft beacons of wind power installations. The sector corresponds to a three-dimensional space or region, which is defined for example by x, y and z coordinates in the switching device.

Such a sector accordingly comprises for example a region or space of which the lower side is defined by the ground surface on which the wind power installations of the wind farm are installed. The upper side of the sector is formed by a surface which lies in its entirety at least several hundred meters above the lower side, for example 600 meters above the lower side. The side surfaces of the sector are also defined such that each of the side surfaces lies at least a few kilometers, in particular four kilometers, away from a contour, defined by the outer-lying wind power installations, of the wind farm in the horizontal direction.

If aircraft therefore enter this region, i.e., the defined sector around the wind farm, the aircraft beacon devices are switched on in order to warn the flying object. If there are no longer any flying objects in the region, i.e., the defined sector, the aircraft beacon devices are switched off. Warning of flying objects at the appropriate time is therefore ensured, while additionally saving energy costs.

According to a further embodiment, each wind power installation of the wind farm has precisely one aircraft beacon device, which comprises in particular two lights, which preferably each emit over 360 degrees horizontally. A flying object can accordingly advantageously sense each individual wind power installation in poor visibility, and adapt the flight path accordingly.

According to a further embodiment, a plurality of subsectors can be defined in the switching device respectively for one or more wind power installations of the wind farm. In particular, for each wind power installation, its own subsector can be defined in the switching device. Each subsector corresponds to a three-dimensional space or region, which is defined by x, y and z coordinates in the switching device.

For this, each subsector comprises for example a region or space of which the lower side is defined by the ground surface on which the wind power installation assigned to the respective subsector or the wind power installations assigned to the respective subsector are installed. The upper side of each subsector is respectively formed by a surface which lies in its entirety at least several hundred meters above the lower side of the respective subsector, for example 600 meters above the lower side. The side surfaces of each sector are defined such that they lie at least a few kilometers, in particular four kilometers, away from the wind power installation or each of the wind power installations assigned to the respective subsector in the horizontal direction. Accordingly, each subsector corresponds to a three-dimensional space, although the subsectors may of course also overlap.

The switching device is also designed to switch on, or to have switched on, the aircraft beacon device of the wind power installation or wind power installations when one or more flying object positions that lie within the subsector defined for the respective wind power installation or wind power installations are detected by means of the evaluation device.

According to another embodiment, the switching device is also designed to switch off, or to have switched off, the aircraft beacon device of the wind power installation or wind power installations when no flying object positions that lie within the subsector defined for the respective wind power installation or wind power installations are detected by means of the evaluation device.

Selective switching on and off of the aircraft beacon devices of the wind power installations is therefore possible. This is particularly advantageous in the case of very large wind farms, which for example have a propagation direction of several kilometers. In the case of such wind farms, it is therefore important only to switch on the aircraft beacon devices of the wind power installations when a flying object enters the subsectors of the respective wind power installations.

It is thus possible in a wind farm that has for example an extent from west to east of 10 kilometers and is approached by a flying object in the region of the western boundary of the wind farm initially to switch on only the westerly lying wind power installations, which are for example at a distance of about 4 to 5 kilometers from the flying object. The aircraft beacon devices lying further to the east may initially stay switched off, so that energy for the operation of these aircraft beacon devices is saved.

According to a further embodiment, a topology of objects and geodata can be stored in the switching device. Preferably, the topology of objects and geodata of the defined sector and/or of the defined subsectors of the wind farm can be stored.

Furthermore, the evaluation device is designed for detecting object positions and geodata by evaluating the images recorded by the camera or camera data and for transferring the detected object positions and geodata to the switching device. Furthermore, the switching device is designed for generating a topology of objects and geodata, in particular of a defined sector and/or of defined subsectors of the wind farm, by observing the variation over time of the transmitted data, or in particular by tagging the time-invariant data. These objects and geodata are accordingly not flying objects, the position of which would of course change when observed over time.

Topological data with the aid of which it can be verified before switching the aircraft beacon on or off whether the flying object detected by the evaluation device is actually a flying object are accordingly stored in the switching device. For example, road or freeway routes can be taken from the topological data, and objects moving in the region of the road or freeway routes can consequently be verified definitively as objects that are not actually flying objects.

Furthermore, the topological data are used to verify the wind farm aircraft beacon system itself. According to one embodiment, it is possible to check or verify whether the wind farm aircraft beacon system is functioning correctly, by the topological data detected by the evaluation device matching stored topological data. In this way it is also possible for example to detect fog, hail or lightning, for example by establishing that the detected topological data do not match stored topological data.

According to a further embodiment, for switching off the at least one aircraft beacon device, the switching device is designed to transmit a data signal, in particular a flag in a broadcasting signal, cyclically to the aircraft beacon device.

Accordingly, no switching-on/off signal is sent to the aircraft beacon devices, but instead a cyclical “suppress beaconing” signal. Cyclical means that the signal is sent repeatedly, at fixed or variable intervals. This signal may be sent in the form of a flag, preferably as a broadcast, to all of the installations to be beaconed, the flag suppressing normal beaconing operation (beaconing off). The flag can consequently also be used as and when required to switch on the beaconing, the suppression being lifted for this, and consequently operation, i.e., a switched-on aircraft beacon device, being carried out as dictated by the situation.

An advantage here is that, in the event of a fault (absence of the flag), a changeover is made to autonomous operation, in which the aircraft beacon device is switched on, and consequently safe operation of the beaconing is ensured.

Provided is a wind farm with a wind farm aircraft beacon system according to one of the previous embodiments.

Provided is a method for beaconing, i.e., for aircraft beaconing, a wind farm. According to the method, electromagnetic waves and/or sound waves are emitted by a transmitting station. Furthermore, electromagnetic waves and/or sound waves are received by at least one receiving station and/or the transmitting station, and positions of flying objects, i.e., flying object positions, are detected by evaluating the emitted and/or received electromagnetic waves and/or sound waves with an evaluation device.

Furthermore, at least one of the aircraft beacon devices is switched on and/or off in dependence on the positions of the flying object positions determined by the evaluation device.

### BRIEF DESCRIPTION OF THE SEVERAL VIEWS OF THE DRAWINGS

Exemplary embodiments of the present invention are explained in more detail below by way of example with reference to the appended figures, in which

FIG. 1 shows a wind power installation,

FIG. 2 shows a wind farm with an exemplary embodiment of a wind farm aircraft beacon system, and

FIG. 3 shows a nacelle of a wind power installation with a camera.

### DETAILED DESCRIPTION

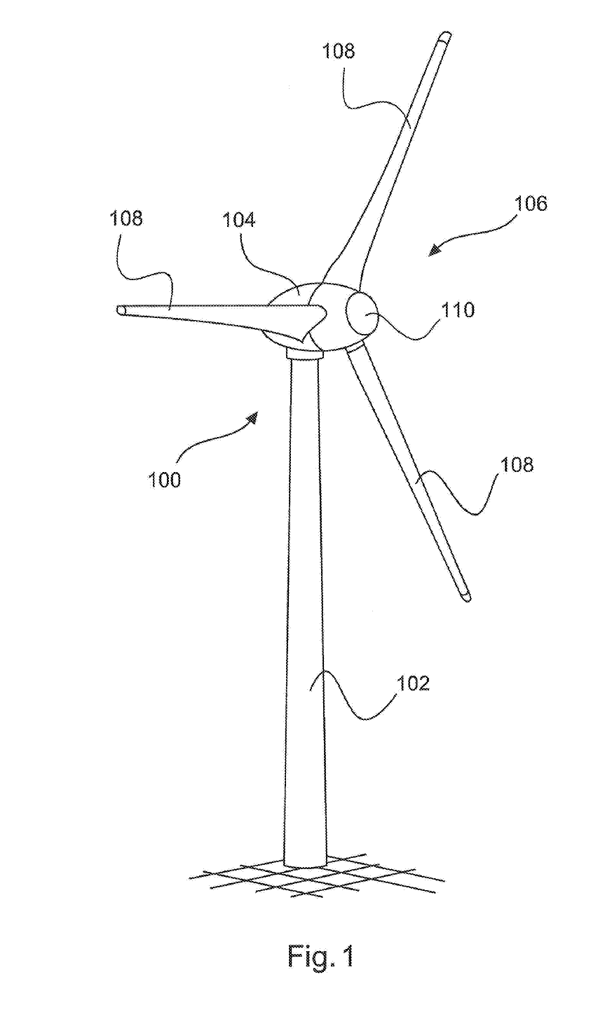

FIG. 1 shows a wind power installation 100 with a tower 102 and a nacelle 104. A rotor 106 with three rotor blades 108 and a spinner 110 is arranged on the nacelle 104. During operation, the rotor 106 is set in a rotational movement by the wind and thereby drives a generator in the nacelle 104.

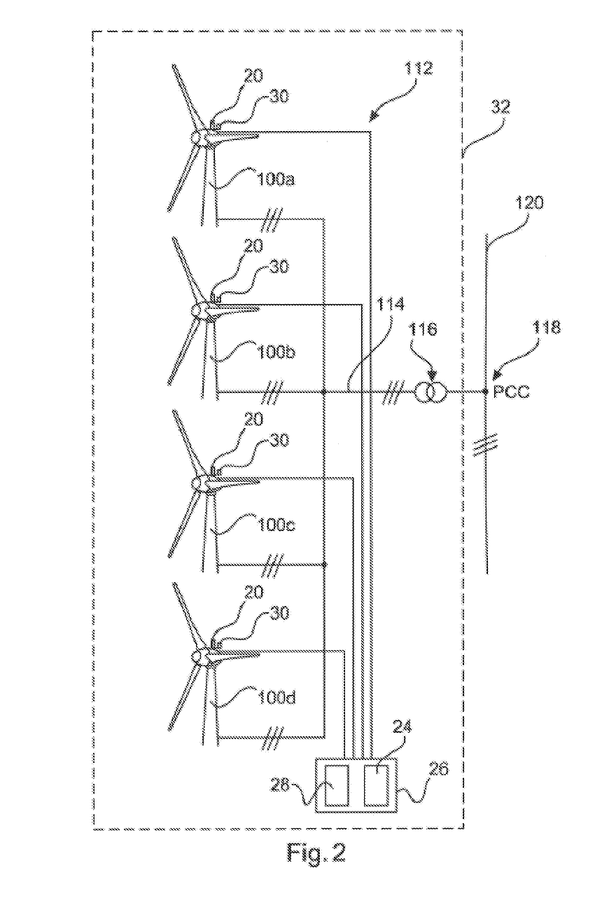

The wind power installation 100 from FIG. 1 may also be operated in conjunction with a plurality of other wind power installations 100 in a wind farm, as described below with reference to FIG. 2.

In FIG. 2, a wind farm 112, with by way of example four wind power installations 100a to 100c, is represented. The four wind power installations 100a to 100d may be the same or different. The wind power installations 100a to 100d are therefore representative of, in principle, an arbitrary number of wind power installations 100 of a wind farm 112. The wind power installations 100 provide their power, i.e., in particular the electricity generated, via an electrical farm grid 114. In this case, the respectively generated electricity or power of the individual wind power installations 100 is added together, and there is usually a transformer 116, which steps up the voltage in the farm in order to feed it into the supply grid 120 at the feed point 118, which is also generally referred to as the PCC.

FIG. 2 is only a simplified representation of a wind farm 112, which for example does not show any power control, even though power control is of course present. It is also possible for example for the farm grid 114 to be designed differently, for example by there also being a transformer at the output of each wind power installation 100, to mention just one other exemplary embodiment.

An exemplary embodiment of the wind farm aircraft beacon system is also represented. Specifically, the wind power installations 100a to 100d each have a camera 20.

With the cameras 20, which here are infrared cameras, images are recorded, that is to say thermal images, and the images recorded are fed in the form of data, that is to say camera data, to an evaluation device 24 that is a component of a controller 26.

In the evaluation device 24, flying object positions, i.e., the positions of flying objects, are determined by evaluating the camera data. For this purpose, moving objects are automatically detected in the images recorded by the cameras for example with image processing software and the distances from the detected objects are determined. A distance determination may be performed for example with a laser range measuring device, which performs a range measurement on the basis of the transit-time principle.

Also provided is a switching device 28, which here is by way of example likewise a component of the controller 26. With the switching device 28, aircraft beacon devices 30 that are arranged on the nacelle 104 of each wind power installation 100a to 100d can be switched on and off. The aircraft beacon devices 30 are accordingly switched on or off in dependence on the flying object positions that have been determined by the evaluation device 24.

For switching off the flight beacon device, for this purpose a data signal is transmitted from the switching device 28 cyclically to the aircraft beacon device 30. This data signal corresponds for example to a broadcasting signal to all of the wind power installations. Accordingly, no switching-on/off signal is sent to the aircraft beaconing devices 30, but instead a cyclical “suppress beaconing” signal. Cyclical means that the signal is sent repeatedly, at a fixed or variable interval.

This signal may be sent in the form of a flag, preferably as a broadcast, to all of the installations to be beaconed, the flag suppressing normal operation of the beaconing (beaconing off). The flag can consequently also be used for switching the beaconing on as and when required. In the case where the signal is absent, the aircraft beacon devices 30 are automatically switched on.

Whether an aircraft beacon device 30 is switched on or off depends on the precise position of the flying object. For this purpose, a sector 32 is defined in the switching device 28. This sector 32 is represented two-dimensionally in FIG. 2 by way of example, although it usually has three-dimensional extents, i.e., for example a width, a height and a depth, the wind power installations 100a to 100d being located essentially at the center of the sector 32.

The sector 32 is also represented in FIG. 2 very close to the wind power installations 100a to 100d, although the outer boundary of the sector 32 may usually be at a distance of several kilometers from the wind power installations, at least in the horizontal direction.

If a position of a flying object, i.e., a flying object position, is detected within this sector 32 by the evaluation device 24, then according to this exemplary embodiment the aircraft beacon devices 30 are switched on, or stay switched on, if another flying object has already been detected beforehand in the sector 32.

In the case in which there is no flying object (any longer) in the sector 32, i.e., no flying object position is detected within the sector 32, the aircraft beacon devices 30 are switched off, or stay switched off.

Here, a sector 32 which “frames” the entire wind farm 112 is represented. According to another exemplary embodiment (not represented here), it is however also possible that, for each wind power installation 100a to 100d, an own subsector is defined and is then separately monitored by the evaluation device 24.

Accordingly, the aircraft beacon 30 of a wind power installation 100a to 100d is switched on in the case in which a flying object enters the respective subsector of a wind power installation 100a to 100d, or is detected in this subsector of the wind power installation 100a to 100d. Selective switching on of individual aircraft beacon devices 30 in dependence on flying object positions is therefore possible. In particular in the case of large wind farms that extend over an area of several kilometers, it is therefore possible for aircraft beacon devices 30 to be activated only in the part of the wind farm 112 that could actually represent a hazard for a flying object.

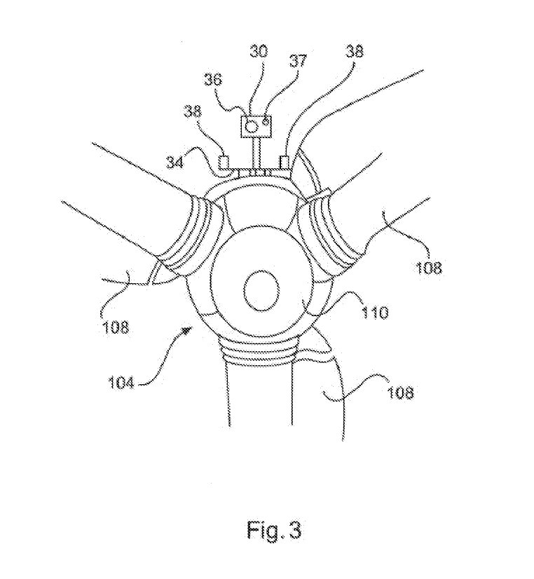

FIG. 3 shows the front view of a nacelle 104 of a wind power installation 100 in an enlarged representation. An antenna carrier 34 is arranged on the nacelle 104 and is firmly connected to the nacelle 104. The antenna carrier 34 has a camera 20. The camera 20 comprises a lens 36 and also a distance measuring device 37, that is to say a laser range measuring device. The camera 20 is horizontally and vertically pivotable.

According to a further embodiment (not represented here), the camera 20 is provided with an optical unit, which allows a 360-degree all-round view. Consequently, in this case no pivoting of the camera 20 is necessary.

Also provided are two lights 38, which together form an aircraft beacon device 30 of the wind power installation 100. The arrangement of the lights 38 at a distance from one another means that the systems are duplicated, so that, despite the partial shadowing by the rotor blades 108, fault-free functioning of the wind farm aircraft beacon system is nevertheless ensured.

1. A wind farm aircraft beacon system, comprising:
at least one aircraft beacon device;
at least one camera configured to record images;
a controller configured to receive camera data indicative of the recorded images from the at least one camera, the controller configured to evaluate the received camera data and determine one or more flying object positions; and
at least one switching device for switching on or off the at least one of the aircraft beacon device in dependence on the flying object positions determined by the controller.

2. The wind farm aircraft beacon system as claimed in claim 1, wherein the camera includes a lens, wherein the lens of the camera and the controller are coordinated in such a way as to sense flying objects that are positioned within a predefined distance of the camera.

3. The wind farm aircraft beacon system as claimed in claim 1, wherein the at least one camera is at least one of: an infrared camera, a photo camera, or a video camera.

4. The wind farm aircraft beacon system as claimed in claim 1, wherein the at least one camera is coupled to a wind power installation and is configured to rotate.

5. The wind farm aircraft beacon system as claimed in claim 1, wherein the at least one camera is a stereoscopic camera or a camera operating based on a stereoscopy process.

6. The wind farm aircraft beacon system as claimed in claim 1 wherein the at least one camera is at least three cameras, each coupled to a respective wind power installation, wherein the at least three cameras are arranged at a same height position as each other.

7. The wind farm aircraft beacon system as claimed in claim 1 further comprising at least one distance measuring device configured to determine distances of flying objects.

8. The wind farm aircraft beacon system as claimed in claim 1 further comprising at least one receiver for receiving signals of a mobile transmitter.

9. The wind farm aircraft beacon system as claimed in claim 1 comprising a sector that includes a plurality of wind power installations, wherein the at least one switching device is configured to switch on, or to have switched on, the at least one aircraft beacon device when one or more flying object positions lie within the sector.

10. The wind farm aircraft beacon system as claimed in claim 9, wherein the at least one switching device is configured to switch off, or to have switched off, the at least one of the aircraft beacon device when no flying object positions lie within the sector.

11. The wind farm aircraft beacon system as claimed in claim 1, wherein the at least one aircraft beacon device is a plurality of aircraft beacon devices, wherein the plurality of aircraft beacon devices are located on respective wind power installations of a wind farm.

12. The wind farm aircraft beacon system as claimed in claim 1, wherein the at least one aircraft beacon device is a plurality of aircraft beacon devices, wherein the plurality of aircraft beacon devices are on a plurality of wind power installations, respectively, wherein the at least one switching device is configured to switch on, or have switched on, a portion of the plurality of aircraft beacon devices when one or more flying object positions are determined to be located within a section the includes a group of wind power installations of the plurality of wind power installations.

13. The wind farm aircraft beacon system as claimed in claim 1, wherein the at least one aircraft beacon device is a plurality of aircraft beacon devices, wherein the plurality of aircraft beacon devices are on a plurality of wind power installations, respectively, wherein the at least one switching device is configured to switch off, or have switched off, a portion of the plurality of aircraft beacon devices when one or more flying object positions are determined to not be located within a section that includes a group of wind power installations of the plurality of wind power installations.

14. The wind farm aircraft beacon system as claimed in claim 1, wherein a topology of objects and geodata, are configured to be stored in the switching device, and
wherein the controller is configured to detect object positions and geodata by evaluating the camera data and configured to transfer the detected object positions and geodata to the switching device, and wherein the switching device is configured to generate a topology of objects and geodata by observing or tagging time-invariant object positions and geodata of the data transferred.

15. The wind farm aircraft beacon system as claimed in claim 1, wherein, switching off the at least one aircraft beacon device comprises transmitting a data signal cyclically to the aircraft beacon device.

16. A wind farm with a wind farm aircraft beacon system as claimed in claim 1.

17. A method comprising:
recording images with at least one camera, wherein the at least on camera is located on a wind power installation;
determining flying object positions by evaluating camera data indicative of the recorded images; and
switching on or off at least one aircraft beacon device in dependence on the positions of the flying object positions.

18. The method as claimed in claim 17 wherein the at least one aircraft beacon device is located on the wind power installation.

19. The method as claimed in claim 17 wherein the at least one camera is a plurality of cameras, each of the cameras being located on a respective wind power installation, wherein recording images comprises recording images from the plurality of cameras, the method further comprising receiving camera data indicative of the recorded images at a controller, wherein determining flying object positions comprises using the controller to determine flying object positions by using the controller to evaluate camera data.

20. The wind farm aircraft beacon system as claimed in claim 1 wherein the at least one camera is a plurality of cameras.
